(19) United States
(12) Patent Application Publication
(10) Pub. No.: US 2012/0084174 A1
(43) Pub. Date: Apr. 5, 2012

(54) DIGITAL CONTENT TRANSACTION SYSTEM AND METHOD USING DOWNLOAD WINDOW

(76) Inventor: Jinho Yang, Gyeonggi-do (KR)

(21) Appl. No.: 12/894,357

(22) Filed: Sep. 30, 2010

(51) Int. Cl. G06Q 30/00

(52) U.S. Cl. 705/26.8; 705/27.1

(57) ABSTRACT

A digital content transaction system using a download window which provides a means for digital content product transaction between a distributor and a purchaser through a distributor device and a purchaser device, the digital content transaction system includes an intermediate system for providing a digital content list screen to allow the distributor to select products to be transacted, generating a download window matching a list of the selected bundle product, copying the download window to a web environment, and providing the copied download window to the purchaser device, wherein a product selection window, in which the bundle product is arranged, is displayed when the download window is clicked by the purchaser device.

### BACKGROUND OF THE INVENTION

1. Field of the Invention

The present invention relates to a system and method for digital content transaction, and more particularly, to a digital content transaction system and method using a download window, which encourages providers to register digital content products and encourages distributors to perform distribution, thereby promoting transactions involving digital content products, and makes it easy and convenient for a purchaser to directly acquire a desired product.

2. Description of Related Art

Recently, with the development of the Internet, transactions of products have been widely made, and especially, transactions involving digital content products, in which music, images, etc. are produced, processed, and distributed in the digital domain, have been actively made.

Transactions of digital content products through the Internet are advantageous in the aspect of convenience in that the user can directly use desired digital content at all times merely by selecting the desired digital content and transmitting payment therefor through the Internet using computers at an office or home, without directly visiting an offline store (e.g. a theater, a disc/DVD store, etc.).

The conventional digital content transaction system is implemented in such a manner that a purchaser accesses a web site possessing various kinds of digital content, joins the web site, searches for a desired product, pays a corresponding price, and then downloads the desired product.

However, the conventional digital content transaction system as described above has the following disadvantages.

In terms of a web site which possesses and provides various kinds of digital content, it is necessary to publicize the web site itself rather than a specific digital content product, so that it is difficult to have a direct marketing effect for the sale of the specific digital content product on a purchaser who desires the specific digital content product.

Also, a purchaser, who desires to purchase a specific digital content product, must be made aware of a web site possessing the corresponding digital content product in advance, or must pass through a search process in order to find the web site, so that it is impossible to actively encourage access and transaction by the purchaser.

In addition, even after accessing a specific web site to purchase a specific digital content product, the purchaser must pass through several steps, including a joining step, a cash charging step, and a desired product searching step, in order to be provided with corresponding digital content, thereby finally being able to acquire the desired digital content product. This complexity of transaction steps acts as a factor that works against a purchaser's intention to purchase a digital content product, thereby reducing the proceeds of the web site operator, and inconveniencing the purchaser because there is no way to simply and easily acquire desired digital content.

The information disclosed in this Background of the Invention section is only for the enhancement of understanding of the background of the invention, and should not be taken as an acknowledgment or any form of suggestion that this information forms the prior art that would already be known to a person skilled in the art.

### BRIEF SUMMARY OF THE INVENTION

Various aspects of the present invention provide a digital content transaction system using a download window and a method for the same, by which the entrepreneur handling an intermediate system can encourage providers to actively register digital content products and encourage distributors to publicize the registered products, thereby activating product transactions and increasing profits, and by which a purchaser can easily and simply acquire a desired digital content product.

In an aspect of the present invention, a digital content transaction system using a download window which provides a means for digital content product transaction between a distributor and a purchaser through a distributor device and a purchaser device, the digital content transaction system comprises an intermediate system for providing a digital content list screen to allow the distributor to select products to be transacted, generating a download window matching a list of the selected bundle product, copying the download window to a web environment, and providing the copied download window to the purchaser device, wherein a product selection window, in which the bundle product is arranged, is displayed when the download window is clicked by the purchaser device.

The digital content list screen includes a bundle product selection box for selecting a digital content targeted by the distributor and a bundle product cart button for temporarily storing a bundle product selected and constructed through the bundle product selection box, wherein a bundle product list window, in which a temporarily-stored bundle product list is arranged, is activated and provided when the bundle product cart button is clicked, and the bundle product list window is provided at a predetermined area thereof with a download window issuance button.

The digital content list screen comprises a bundle product selection box for selecting a digital content targeted by the distributor, and the digital content list screen is provided at a predetermined area thereof with a download window issuance button.

The download window issuance button is clicked, a bundle product code for distinction from other distributors and other bundle products is issued, and a download window comprising the bundle product code as meta information is generated and provided to a clipboard of the distributor device.

The product selection window provided when the download window is clicked comprises: a product selection box for selecting a product desired by the purchaser; and a download button for downloading the selected product and processing payment.

The product selection window further comprises a search window for searching the intermediate system for a digital content other than a bundle product arranged in the product selection window and additionally providing the searched digital content.

The bundle product list window, which is activated when the bundle product cart button is clicked, provides a sales policy setup column so that the distributor directly sets a sales policy, or a sales policy setup window for setting a sales policy is provided when the download window issuance button is clicked.

The intermediate system requests a provider device, which is to register a digital content product with the intermediate system, to set whether generation of a download window for the digital content product to be registered is allowed.

The download window is provided in at least one form selected from image, hyper text makeup language (HTML), and uniform resource locator (URL) forms.

The providing the download window in the image form is achieved by a series of executions of establishing an area on which the image exists, selecting the area, and copying the image on a clipboard of the distributor device.

The bundle product code is constituted with a combination of numbers or alphabet characters.

In another aspect of the present invention, a digital content transaction system using a download window which provides a means for digital content product transaction between a distributor and a purchaser through a distributor device and a purchaser device, the digital content transaction system includes an intermediate system for providing a digital content list screen to allow the distributor to select digital contents desired to be transacted, extracting an electronic fingerprint for confirmed digital contents, generating and issuing a download window matching the extracted electronic fingerprint, and copying the issued electronic fingerprint to a web environment, wherein, when the displayed download window is clicked by the purchaser device, a digital content list related to the electronic fingerprint matching the download window is extracted from digital contents stored in the intermediate system, and the extracted digital content list is provided to the purchaser device.

In another aspect of the present invention, a digital content transaction system using a download window which provides a means for digital content product transaction between a distributor and a purchaser through a distributor device and a purchaser device, the digital content transaction system includes an intermediate system for allowing the purchaser device to register digital contents of interest which the purchaser prefers, setting an extraction factor for searching and extracting a content related to the registered digital content of interest from digital contents stored in the intermediate system, generating and issuing a download window matching the extraction factor, and copying the issued download window to a web environment, wherein, when the displayed download window is clicked by the purchaser device, a digital content product list related to the extraction factor matching the download window is provided to the purchaser device.

The extraction factor comprises at least one selected from an electronic fingerprint, a search word, and a related term for digital content which is selected by the purchaser device.

The download window generated and issued by the intermediate system is provided to an email address which has been registered with the intermediate system by the purchaser.

In another aspect of the present invention, a digital content transaction method using a download window which provides a means for digital content product transaction between a distributor and a purchaser through a distributor device and a purchaser device, the digital content transaction method includes: allowing the distributor to select transaction products, which are to be transacted among a list of registration products registered by the distributor, on a digital content list screen; generating a download window to which the selected transaction products are allocated and in which a bundle product code for distinction from other distributors and other bundle products is included as meta information; copying the generated download window to a web environment and providing the copied download window to the purchaser device; providing a product selection window, in which a bundle product list is arranged, when the download window is clicked by the purchaser device; and allowing the purchaser device to select a desired specific product from a bundle product provided through the product selection window, and requesting a payment to be made.

The digital content list screen includes a bundle product selection box for selecting a digital content targeted by the distributor; and a bundle product cart button for temporarily storing a bundle product selected and constructed through the bundle product selection box, wherein a bundle product list window, in which a temporarily-stored bundle product list is arranged, is activated and provided when the bundle product cart button is clicked, and the bundle product list window is provided at a predetermined area thereof with a download window issuance button.

The digital content list screen comprises a bundle product selection box for selecting a digital content targeted by the distributor, and the digital content list screen is provided at a predetermined area thereof with a download window issuance button.

When the download window issuance button is clicked, a bundle product code for distinction from other distributors and other bundle products is issued, and a download window comprising the bundle product code as meta information is generated and provided to a clipboard of the distributor device.

The product selection window provided when the download window is clicked comprises: a product selection box for selecting a product desired by the purchaser; and a download button for downloading the selected product and processing payment.

The product selection window further comprises a search window for searching the intermediate system for a digital content other than a bundle product arranged in the product selection window and additionally providing the searched digital content.

The bundle product list window, which is activated when the bundle product cart button is clicked, provides a sales policy setup column so that the distributor directly sets a sales policy, or a sales policy setup window for setting a sales policy is provided when the download window issuance button is clicked.

The download window is provided in at least one form selected from image, hyper text makeup language (HTML), and uniform resource locator (URL) forms.

The providing the download window in the image form is achieved by a series of executions of establishing an area on which the image exists, selecting the area, and copying the image on a clipboard of the distributor device.

### BRIEF DESCRIPTION OF THE DRAWINGS

FIG. 1 is a block diagram illustrating the configuration of a digital content transaction system using a download window according to an embodiment of the present invention;

FIG. 2 is a view illustrating a list of digital content according to a first embodiment of the present invention;

FIG. 3 is a view illustrating a bundle product list window and a download window issuance button according to the first embodiment of the present invention;

FIG. 4 is a view illustrating a web environment in which a download window is displayed according to the first embodiment of the present invention;

FIG. 5 is a view illustrating a product selection window according to the first embodiment of the present invention;

FIG. 6 is a flowchart illustrating the procedure of a digital content transaction method using a download window according to the first embodiment of the present invention; and

FIG. 7 is a view explaining a digital content transaction system using a download window according to a second embodiment of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

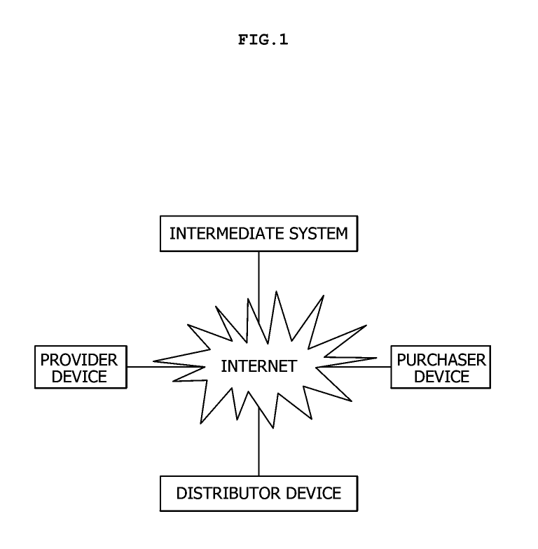

FIG. 1 is a block diagram illustrating the configuration of a digital content transaction system using a download window according to an embodiment of the present invention.

Referring to FIG. 1, the digital content transaction system using a download window according to an embodiment of the present invention includes an intermediate system, a provider device, a distributor device, and a purchaser device, which are connected to each other over the Internet and are configured to enable transactions of various digital content products based on web environments provided on the Internet.

Also, the digital content transaction system according to the present invention has a characteristic in that it is possible to select optional digital content products from a plurality of digital content products, to reconstruct the selected digital content products in the form of a bundle of digital content products, and to freely display and publicize the reconstructed digital content products in various web environments, thereby encouraging transaction of digital content products and enabling a purchaser to easily and conveniently acquire a desired product without delay.

The digital content transaction system using a download window according to the present invention is based on a web environment provided on the Internet, such as a homepage, a blog, an internet cafe, an email, etc., and has a basic characteristic such that a means for enabling a transaction involving a plurality of digital content products between a provider, a distributor, and a purchaser is provided through an intermediate system, a distributor device, and a purchaser device. The intermediate system is configured to accept registrations of digital content products from a provider device, and to store and manage information on the registered digital content products, and the distributor device is configured to have access to the intermediate system and the web environment. The purchaser device is configured to have access to the web environment.

The web environment designates an Internet site, to which the distributor device and the purchaser device can have access, and specifically, represents a cyberspace on the Internet, such as a personal/corporate homepage, an Internet community site, a forum, a mini homepage, a blog, a web bulletin board, an email, etc. The web environment includes all types of cyberspaces in which a download window provided from the intermediate system to a distributor can be displayed.

The term “provider” used in this document represents a person or entrepreneur that possess digital content products of music, images, and so on, produced/processed in a digital scheme, and registers the possessed digital content products with the intermediate system so that many unspecified persons can purchase the digital content products, thereby making profits. For example, the provider may be a personal provider who possesses various music and movie files, or may be the record/film distributing company that owns the copyright on a produced music or film file. That is, anyone who possesses digital content can be the provider.

The provider device represents a device, such as an electronic information terminal or a computer, which is handled by the provider, is connected to the intermediate system through the Internet, and functions to provide login access to the intermediate system and to transmit and register various digital content data.

The term “distributor” used in this document represents a person, who selects optional digital content products from various digital content products registered with the intermediate system by a provider, reconstructs the selected digital content products in a bundle of digital content, and displays and publicizes the bundle of digital content in the web environment, thereby encouraging the transaction of digital content products and enabling a purchaser to easily and conveniently use a desired product without delay.

The distributor device represents a device, such as an electronic information terminal or a computer, which is handled by the distributor, and is connected to the intermediate system through the Internet. The distributor device functions to provide login access to the intermediate system, to construct a bundle of digital content, to receive a download window allocated to the bundle of digital content, and to display the received download window in the web environment.

The purchaser device represents a normal computer, which performs payment and downloading processes through a download window displayed in cyberspace on the Internet when the purchaser intends to purchase a specific digital content item through the web environment.

The intermediate system functions to accept registrations of digital content products from the provider device, to store and manage information on the registered digital content products, and to issue a download window, to be described later, to the distributor device. Also, the intermediate system is connected to a financial agency system and/or a credit card system. Since the present invention does not refer to a financial agency system or a credit card system, the following description will be given on the assumption that the financial agency system includes a credit card system, without distinguishing between the financial agency system and the credit card system.

Specifically, the intermediate system corresponds to a system providing a means for supporting transactions between the provider, the distributor, and the purchaser when the provider, the distributor, and the purchaser transact digital content through the use of the web environment provided on the Internet. The intermediate system accepts registrations of the provider and distributor, who desire to use the intermediate system, as members, and processes tasks for intermediation and transaction of digital content products.

The intermediate system includes a device, generally called a server computer, equipped with an input/output unit, and includes a product database unit, a cart database unit, a member database unit, and a transaction database unit. The product database unit stores digital content data registered from the provider device, a bundle product list finally selected by the distributor device, and a bundle product code allocated to the bundle product list. The cart database unit temporarily stores a list of digital content which the distributor device selects to construct the bundle product list. The member database unit manages and stores member joining information (e.g. a member name, a member ID, a password, a member code, etc.) on the provider and distributor, and an issuance history of the bundle product code. The transaction database unit stores information on transactions of digital content, generated through a download window according to the present invention.

Pruna, Fileguri, and Wedisk, which are web sites based on a Peer-to-Peer (P2P) system, are representative sites performing a function similar to that of the intermediate system according to the present invention. Such a web site accepts registrations of various digital content data from providers, stores/manages the registered digital content data, and allows a purchaser to use the registered digital content as a member so that the purchaser can be provided with various kinds of digital content.

The digital content transaction system using a download window according to an embodiment of the present invention provides the distributor with a bundle product construction function and a download window according to the present invention, and provides the purchaser with a product selection window based on an existing P2P system as described above, so as to maximize accessibility, which is especially important in the transaction of digital content products, and the capability of simultaneously providing products in a similar category, thereby encouraging the transaction of digital content products and enabling the purchaser to easily and conveniently acquire a desired product without delay.

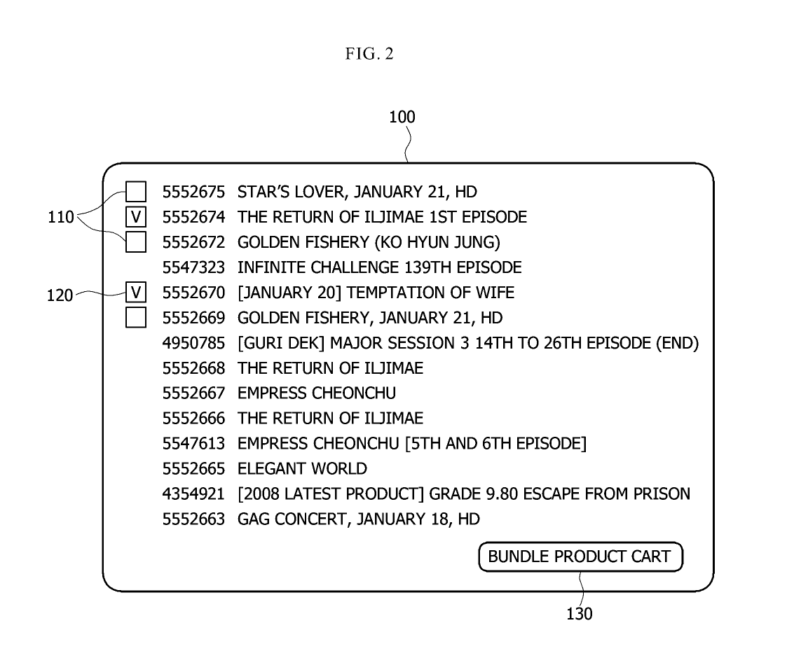

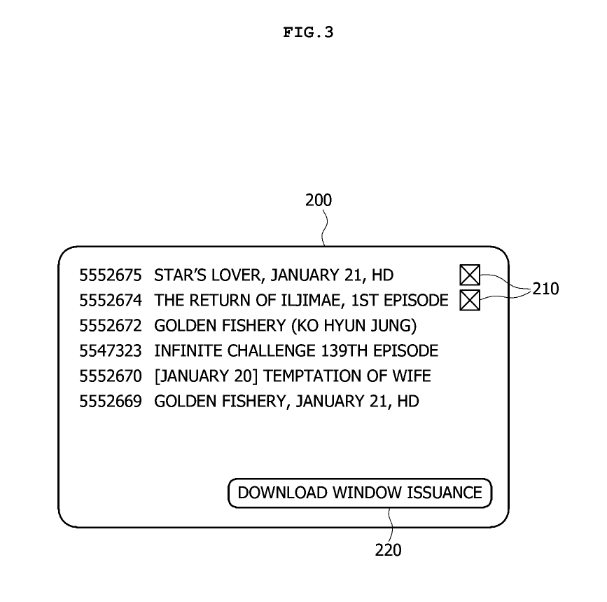

FIG. 2 is a view illustrating a list of digital content according to a first embodiment of the present invention, and FIG. 3 is a view illustrating a bundle product list window and a download window issuance button according to the first embodiment of the present invention.

Referring to FIGS. 2 and 3, the intermediate system provides a distributor device with a screen 100 (hereinafter, referred to as a “digital content list screen 100”), on which a list of digital content products are registered by providers, so that a corresponding distributor can select products for transaction.

The digital content list screen 100 provided to the distributor device is provided in the same manner as that used in an existing web site providing P2P service, and hereinafter, only the differences between the digital content list screen 100 and existing screens will be described.

As shown in FIG. 2, when a distributor searches a category or the like in order to construct a digital content bundle product coincident with a category or genre targeted by the distributor, the distributor is provided with a digital content list screen 100, in which digital content titles representing corresponding digital content are arranged.

The bundle product corresponds to a list of digital content products which are reconstructed by selecting digital content coincident with the purpose of the distributor, and the distributor is issued a download window corresponding to a bundle product and displays the download window in the web environment.

Therefore, in order to construct a bundle product, it is necessary for the distributor to select and reconstruct digital content. A “bundle product selection box” and a “bundle product cart button” according to an embodiment of the present invention are means for achieving the above purpose. Each digital content title arranged in the digital content list screen 100 is provided with a bundle product selection box 110 for the construction of a bundle product, and a bundle product cart button 130 is provided in a predetermined area of the screen 100. The bundle product cart button 130 is a means for temporarily storing a bundle product selected using the bundle product selection box 110.

According to the first embodiment of the present invention, shown in FIG. 2, the bundle product selection box 110 has the shape of a rectangular box, and, when the distributor enters a check mark “√” 120 in a box, a corresponding digital content item is temporarily stored in the cart database unit.

The bundle product cart button 130 according to an embodiment of the present invention is useful in constructing a bundle product with various categories or a large amount of digital content.

That is, when the distributor is to construct one bundle product with digital content of various categories or genres, the distributor is provided with a new digital content list screen whenever each category is searched. In this case, the distributor repeats a procedure of selecting a desired product and adding the selected product to the bundle product cart button 130 in each newly provided digital content list screen, thereby being able to construct a bundle product including content in various categories.

When a bundle product has been constructed as described above, a download window corresponding to the bundle product is generated and issued in accordance with the present invention.

When the distributor, having completed the selection of a plurality of digital content items, clicks the bundle product cart button 130 shown in FIG. 2, a bundle product list window 200, combined/constructed through the aforementioned selection procedure, is activated and provided as shown in FIG. 3. In this case, the distributor may perform an additional task of deleting/adding a digital content item from/to digital content items displayed in the bundle product list window 200. That is, the distributor may add a new digital content to the bundle product list window 200 by again performing the “add to cart” task, and may delete an unnecessary digital content item from the bundle product list window 200 by clicking a delete button 210 provided corresponding to each digital content title.

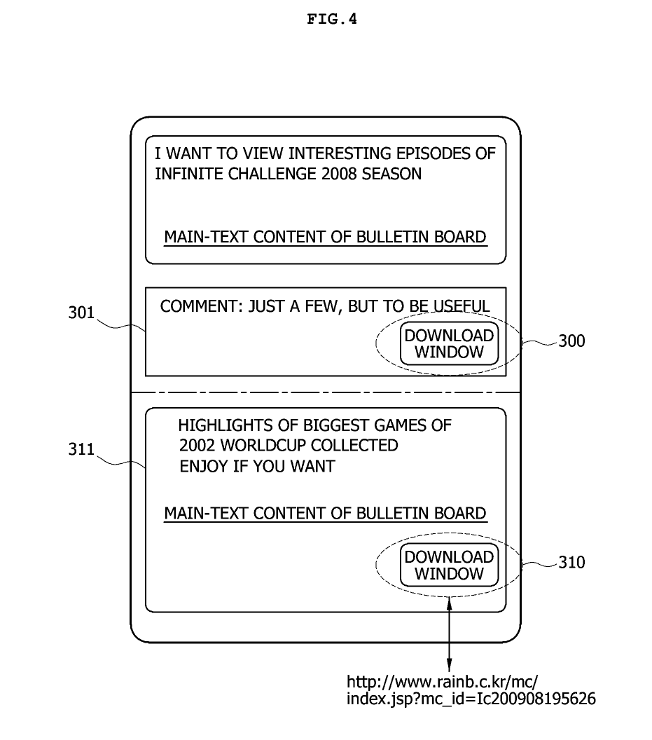

According to an embodiment of the present invention, the bundle product list window 200 includes a download window issuance button 220 in a predetermined area thereof. When the final construction of a bundle product list desired by the distributor has been completed through the aforementioned procedure, the download window issuance button 220 functions to request the intermediate system to issue a download window 330 or 340, as shown in FIG. 4, allocated to the corresponding bundle product.

That is, when the distributor clicks the download window issuance button 220 in the bundle product list window 200, the intermediate system issues a download window code, and simultaneously generates and provides a download window including the bundle product code as meta information to the distributor device. The bundle product code is a distributor identifier for distinguishing a distributor and/or a bundle product from other distributors and/or bundle products, and is constituted with a combination of alphabet characters and numbers.

After the corresponding content of a download window issued through the click of the download window issuance button 220 has been copied onto the clipboard of the distributor device, the distributor displays the download window in such a manner as to paste the download window in the web environment, thereby publicizing a bundle product of digital content constructed by the distributor and generating transactions thereof.

According to an exemplary embodiment of the present invention, three forms of download windows are provided: an image form to be used in an image bulletin board, a Hyper Text Makeup Language (HTML) form, and a Uniform Resource Locator (URL) form.

An example in which source code for performing copy onto a clipboard in order to provide an image-type download window in the web environment is implemented with the Javascript “function copy_all( )” is as follows:

```
  function copy_all( )
{
      var text =
document.item.document.body.createTextRange( );
      text.select( );
      text.execCommand(“Copy”);
}
```

The first sentence “var text” designates an area of an image to be copied, the second sentence “text.select( )” corresponds to an instruction to select the corresponding area, and the last sentence corresponds to an instruction to copy the selected area onto the clipboard of the distributor device.

An example of an HTML-type source code is as follows.

```
  function copy_html( ){
      var ele = document.item.document.body;
      var maintext = ele.innerHTML;
      window.clipboardData.setData(“Text”, maintext);
}
```

Here, after an object is stored in “document.item.document.body”, the object is stored in a variable in main text, and corresponding content is copied onto the clipboard of the distributor device.

A URL-type source code may be implemented as follows.

```
  function copy_link( ){
      var maintext =
“http://www.wedisk.com/mc/index.jsp?mc_id=bundle product
code”;
      indow.clipboardData.setData(“Text”, maintext);
}
```

In the three forms of download windows, “http;//www.wedisk.com/mc/index.jsp?mc_id=bundle product code” is recorded as meta information.

FIG. 4 is a view illustrating a web environment in which a download window is displayed according to the first embodiment of the present invention. The method of utilizing the download window according to the present invention will be described with reference to FIG. 4. A distributor who is very interested in the arts/entertainment field may select digital content coincident with a corresponding purpose from among digital content products of an arts/entertainment category, which have been registered in the intermediate system, construct a bundle product with the selected digital content, copy a download window 310 issued only to the distributor and the constructed bundle product, and display the download window 310 on an arts/entertainment-related café, his/her own homepage/blog, etc. 311.

Otherwise, as shown in FIG. 4, when a purchaser having posted a piece of writing on a specific genre/category-related internet café bulletin board or the like requests digital content, the distributor may select only the requested digital content, construct a download window 300 with the selected digital content, and paste the download window 300 on a comment box 310 of the bulletin board, so that the purchaser can easily and conveniently acquire and enjoy the desired digital content without delay, and the distributor can encourage transactions involving digital content products.

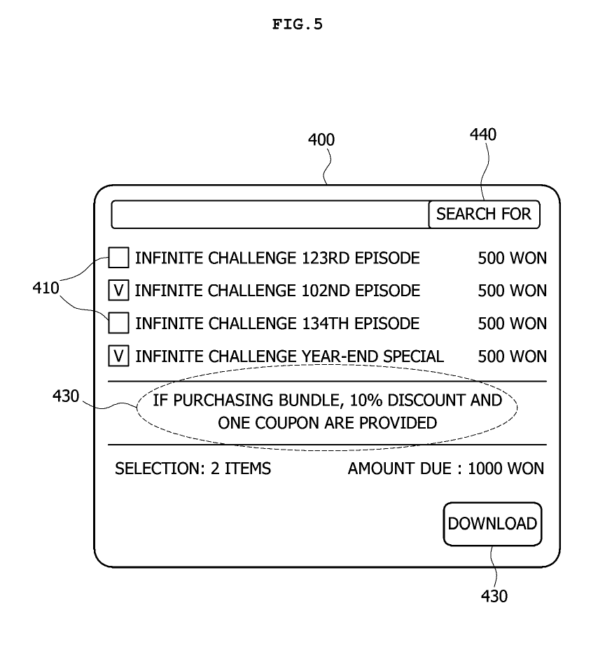

FIG. 5 is a view illustrating a product selection window according to the first embodiment of the present invention. Referring to FIG. 5, when a purchaser clicks a download window, which has been displayed by a distributor on a bulletin board of a specific café, blog, or the like, a popup window (hereinafter, referred to as a “product selection window”) 400, which includes a bundle product list matching the clicked download window, is displayed and provided to the purchaser.

In the product selection window 400, a digital content list constructed by the distributor is arranged, in which each digital content item has a product selection box 410 having a rectangular shape so that the purchaser can select a desired product in a “√” mark checking manner.

In addition, the product selection window 400 is provided at a predetermined area thereof with a download button 420 for the purchaser to download and pay for a selected product. When the purchaser, having selected one or more desired digital content products, clicks the download button 420, a payment window, including payment information and a payment mode selection column, pops up.

Specifically, the download button 420 may be divided into and constituted with a selective download button and “download all” button. The selective download button allows payment and download of only one or more digital content products selected in the “√” mark checking manner. In contrast, when the “download all” button is clicked, all of the digital content products displayed in the product selection window are automatically selected, and all of the digital content products are paid for and downloaded.

The payment information represents information, including a list of digital content selected by the purchaser, an amount due, and a discount. The payment mode may include existing payment modes, such as payment using a mobile terminal, payment using a credit card, and deposit without a bankbook, which are widely in use.

The payment processing and its means through a click of the download button are the same as those in the existing escrow payment system, so a detailed description thereof will be omitted.

When payment has been completed in a predetermined payment mode, data of corresponding digital content is transmitted to a purchaser device of the purchaser having made the payment, so that the purchaser can ultimately acquire a desired product.

Also, in the product selection window 400, a bundle product sales policy may be displayed to provide purchasers with information on benefits based on purchase amounts. The bundle product sales policy 430 includes various sales strategies for promoting sales by distributors and providing a purchaser with benefits, such as applying a discount rate and/or giving coupons corresponding to the amount of digital content included in the purchased bundle product.

According to an exemplary embodiment of the present invention, the bundle product sales policy may be set by a provider or a distributor, and setup schemes of the bundle product sales policy according to the entity setting up the bundles are as follows.

First, in the case where a distributor is to set a sales policy, a sales policy setup column is provided on the bundle product list window 200 of FIG. 3, activated when the cart button 130 of FIG. 2 according to the present invention is clicked, so that the distributor can directly set a sales policy. Otherwise, a sales policy setup window (not shown) for setting a sales policy may be provided when the download window issuance button 220 is clicked. Although either of the two cases is applicable, information on a sales policy set by the distributor is matched and stored with a bundle product code allocated to the distributor.

Next, in the case where a provider is to set a sales policy, a sales policy setup column is provided when a provider registers digital content products with the intermediate system, so that the provider can directly set a sales policy for the registered products.

The product selection window 400 is provided at a predetermined area with a search window 440 so that additional digital content can be searched for. The search window 440 is used when a purchaser wishes to additionally purchase digital content other than the digital content arranged in the product selection window. For example, it is assumed that a specific purchaser posts a piece of writing on an internet bulletin board in order to purchase digital content of an entertainment program entitled “Infinite Challenge” from the 112^{th} episode to the 115^{th} episode, and then a specific distributor constructs a bundle product of corresponding digital content (i.e. from the 112^{th} episode to the 115^{th} episode of Infinite Challenge) and displays a download window for the bundle product on the internet bulletin board.

In this case, when the purchaser is provided with desired digital content (i.e. from the 112^{th} episode to the 115^{th} episode of Infinite Challenge) through the download window 300, and then desires to directly purchase other digital content (e.g. Infinite Challenge Year-End Special) in addition to the bundle product, the purchaser can search for “Infinite Challenge Year-End Special” through the search window 440 according to the present invention and additionally purchase the corresponding digital content with ease.

The digital content acquired through the search window 440 is provided from the product database unit of the intermediate system. That is, the intermediate system searches the product database unit for digital content corresponding to the search term input through the search window 440, and provides the result of the search to a searcher in the same form as the product selection window 400, so that the purchaser can directly acquire additionally desired digital content with ease.

The aforementioned digital content transaction system according to an embodiment of the present invention is implemented in such a manner that a distributor selects digital content from among digital content registered by a provider, constructs a bundle product with the selected digital content, and displays a download window allocated to the bundle product in the web environment, thereby leading purchasers to purchase the bundle product.

However, there may be a specific provider who does not desire a distributor to select a product registered by him/her and to construct a bundle product with his/her own product.

Taking this case into consideration, the digital content transaction system using a download window according to an embodiment of the present invention is constructed such that it is possible to set whether or not a distributor is allowed to generate a download window. That is, a provider sets whether or not a distributor is allowed to select his/her own registration product and to construct a bundle product with his/her own registration product. The setup is implemented in such a manner that, when a provider registers specific digital content with the intermediate system, a setup window for requesting the provider to set whether or not generation of a download window is allowed is provided, and information on whether or not generation of a download window for the specific digital content is allowed, input through the setup window, is stored in the product database unit of the intermediate system.

When the provider allows a bundle product to be constructed, it may be additionally required to set a policy including profit share information as follows. That is, when a provider having registered a specific digital content product allows generation of a download window for the specific product, the provider is required to set a registration product transaction mediation policy, such as a profit-sharing rate (e.g. a predetermined percentage (%) of sale proceeds) to be allocated to a distributor who selects the registration product, constructs a bundle product, and completes a transaction. The setup of the transaction mediation policy may be achieved in such a manner as to provide a policy setup window in a download window generation allowance setup window, which is provided when the provider registers specific digital content with the intermediate system, too.

Also, in order to maintain consistency and to prevent unnecessary competition between providers, the aforementioned transaction mediation policy may be implemented in such a manner that the intermediate system sets and applies a transaction mediation policy across the board, and each provider sets only whether or not to allow generation of a download window.

As described above, the digital content transaction system using a download window according to an embodiment of the present invention is constructed in such a manner as to divide the proceeds, obtained through the download window, between the distributor who displayed the download window and the provider of the digital content included in the bundle product that was constructed by the distributor.

Through this sale proceeds distribution system, the entrepreneur handling the intermediate system encourages providers to register digital content products, and thus can possess various kinds of content, and also encourages the distributor to actively publicize registered products, and thus can promote transactions involving digital content products.

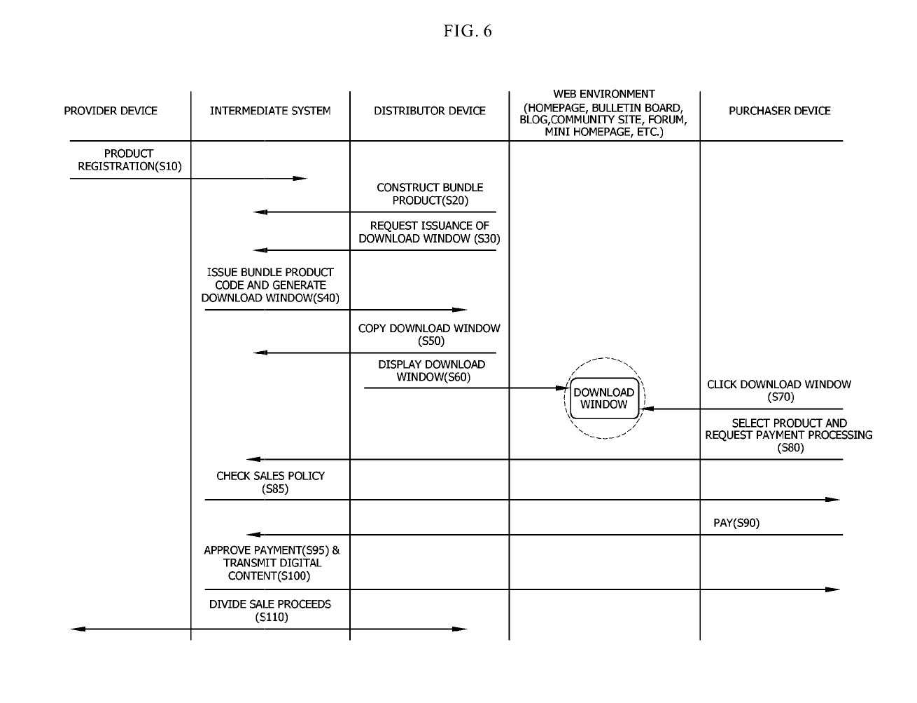

FIG. 6 is a flowchart illustrating the procedure of a digital content transaction method using a download window according to the first embodiment of the present invention.

Hereinafter, the digital content transaction method using a download window according to the first embodiment of the present invention and the related procedure will be described with reference to FIG. 6.

The digital content transaction method starts from step 10, where a provider who possesses digital content products including music, images, and so on, produced/processed in the digital domain, registers the possessed digital content products with the intermediate system. The digital content products registered by the provider are stored in the product database unit of the intermediate system.

In addition, although it is not shown in FIG. 6, the digital content transaction method may further include a step (e.g. step 15) of, when a provider registers a specific digital content product in step 10, requesting the provider, who wants to register the digital content product with the intermediate system, to set a registration product transaction mediation policy, including whether or not generation of a download window for the registered product is allowed, and a profit sharing rate obtained through the download window issued to the distributor.

The intermediate system takes possession of various digital content products through step 10. Then, a distributor accesses the intermediate system, which possesses various digital content products, selects digital content products that match the distributor's purpose from among digital content products registered by providers with the intermediate system, and constructs a bundle product with the selected digital content products in step 20.

The construction of the bundle product is achieved by a selection action through a bundle product selection box and by a bundle product construction action through a bundle product cart button according to an embodiment of the present invention. When the construction of the bundle product has been completed through the selection action and the construction action, the distributor clicks a download window issuance button included in a bundle product list window, which is provided when the bundle product cart button is clicked, thereby requesting the intermediate system to issue a download window to be allocated to the bundle product in step 30.

In response to the request, the intermediate system issues a bundle product code for distinguishing the corresponding distributor and bundle product from other distributors and bundle products, and generates and provides a download window, including the bundle product code as meta information, to the distributor device in step 40.

Although it is not shown in FIG. 6, the method may further include a step (e.g. step 45) of, when the bundle product code is issued, the intermediate system requesting that a bundle product sales policy be set, the policy including various sales strategies for promoting sales by distributors and providing a purchaser with benefits, such as applying a discount rate and/or awarding coupons according to the number/amount of digital content included in a purchased bundle product.

The download window is provided in image form to be used in an image bulletin board, HTML form, or a URL form. The distributor selects one of the three forms of download windows, and copies the download window of the selected form on the clipboard of the distributor device in step 50.

A bundle product sales policy set by the distributor and a bundle product code issuance history generated through steps 40 and 50 are stored in the member database unit of the intermediate system.

The distributor, having been issued the download window, displays the download window by pasting the download window into various web environments in step 60. When a purchaser clicks the download window displayed by the distributor in the web environments, the purchaser is provided with a product selection window in which a bundle product list connected with the download window is arranged in step 70.

When the purchaser decides to purchase some digital content products selected from the bundle product which are provided through the product selection window, the purchaser clicks a download button provided in the product selection window after completing the selection of target products, thereby requesting processing of payment for the selected products in step 80.

Also, when the purchaser has sent a request for payment for the selected products in step 80, the intermediate system checks the sales policy that has been set in the download window clicked by the purchaser, and then applies the sales policy to the purchaser who uses the download window in step 85.

When actual payment has been made in step 90 and the payment has been accepted in step 95 through an existing payment means, such as an escrow payment service, the intermediate system transmits corresponding digital content products to the purchaser device of the purchaser in step 100, so that the purchaser acquires desired digital content products.

After actual product transaction and payment have been completed through the download window displayed by the distributor, a step of dividing sales proceeds is performed. That is, based on a profit-sharing rate set by a provider or set by the intermediate system across the board, sales proceeds obtained through the payment for the purchased products are divided between the provider and the distributor in step 110.

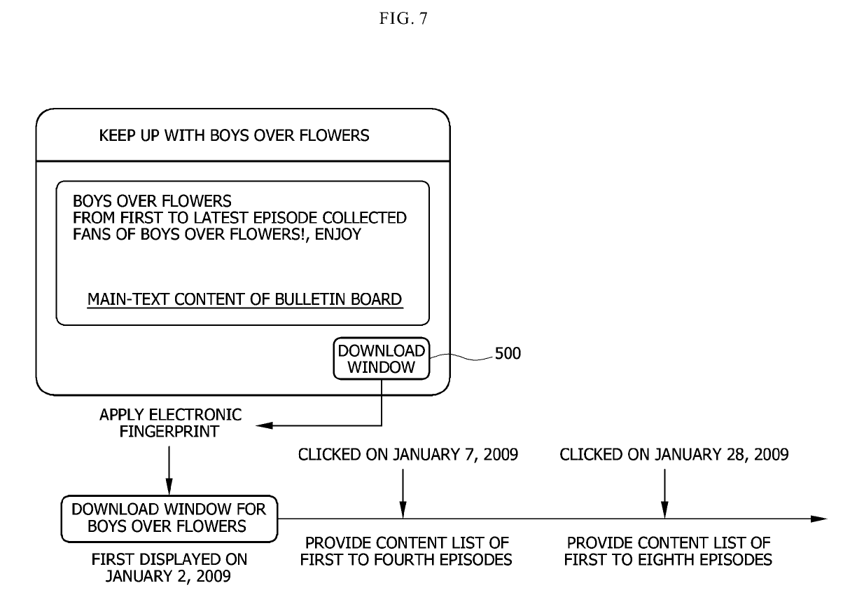

FIG. 7 is a view explaining a digital content transaction system using a download window according to a second embodiment of the present invention.

According to the first embodiment of the present invention, the digital content transaction system using a download window is constructed such that a distributor constructs a bundle product, is issued a download window corresponding to the bundle product, and displays the download window in the web environments, thereby providing a means for transacting digital content.

However, according to the digital content transaction system using a bundle product construction scheme, as described above, a consumer clicks a download window, and is provided only with digital content that has been selected and chosen for inclusion in a bundle product by a distributor, thereby having the following defects.

For example, with respect to a currently airing weekend drama, it is assumed that there is a distributor who constructs a bundle product with the latest episode of the drama and displays the bundle product in a web environment in real time whenever the latest episode of the drama has ended. In this case, when the distributor desires to consecutively provide digital content aired through a plurality of episodes in real time, the distributor must repeat the aforementioned bundle product construction and download window issuance tasks whenever a new episode of the drama airs, which is troublesome for the distributor.

Also, in the case of a customer who accesses a specific web environment, in which the distributor is displaying the download window, and acquires desired digital content, if the distributor does not display a new download window including a list of new episodes of a drama, the customer must search and access a web environment, other than the specific web environment having been used by the customer, in order to acquire the latest episode of the drama, which is inconvenient for the customer.

According to the second embodiment of the present invention, a digital content transaction system using a download window is constructed such that, once a download window using an electronic fingerprint is generated and is first displayed, digital content of the latest episode can be consecutively provided through the first displayed download window in real time.

Therefore, the download window using an electronic fingerprint according to the present invention is suitable for a transaction system for digital content which is not completed as one file, but is consecutively produced over a predetermined period.

In terms of the basic technical characteristics and transaction method, the digital content transaction system using a download window according to the second embodiment of the present invention is the same as the digital content transaction system for constructing a bundle product and exposing a download window according to the first embodiment of the present invention, and thus the following description will give only the difference between the two systems.

Referring to FIG. 7, according to the second embodiment of the present invention, an electronic fingerprint is extracted from digital content, and a download window corresponding to the electronic fingerprint is generated and issued, instead of allowing a distributor to explicitly select specific digital content products and construct a download window. Hereinafter, a download window according to the second embodiment of the present invention will be referred to as an “electronic fingerprint download window.”

When a distributor desires to be issued an electronic fingerprint download window, the distributor does not need to explicitly select specific digital content to construct the aforementioned bundle product, but the distributor has merely to check and input basic information, such as the category to which the digital content desired to be displayed by the distributor belongs, the title of the digital content, etc., to extract an electronic fingerprint.

That is, when a distributor accesses the intermediate system, and performs a search for digital content corresponding to a target category or genre, the distributor is provided with a digital content list screen, similar to the first embodiment of the present invention.

Each digital content title arranged in the digital content list screen is provided with a content selection box, and an electronic fingerprint download window issuance button is provided in a predetermined area of the screen. Specifically, the content selection box has the shape of a rectangular box. When the distributor selects desired digital content, enters a check mark “√” 120 in a corresponding box, and clicks the electronic fingerprint download window issuance button, the intermediate system extracts an electronic fingerprint from each checked and input digital content item.

The electronic fingerprint is a hash value allocated to each digital content item, and is a unique identifier attached to each digital content item, like the fingerprints of people. Generally, the hash value of each electronic fingerprint is constituted as a 32-digit number, and includes information on the file's size, title, extension, etc.

When an electronic fingerprint for the digital content selected by the distributor has been extracted as described above, an electronic fingerprint download window corresponding to the electronic fingerprint is generated and issued to the distributor. Like the first embodiment of the present invention, the electronic fingerprint download window issued to the distributor is constructed so that it is possible to copy the electronic fingerprint download window in at least one form selected from among an image form, an HTML form, and a URL form, and to display the copied electronic fingerprint download window in a web environment targeted by the distributor.

Also, similar to the bundle product code according to the first embodiment of the present invention, the issued electronic fingerprint download window includes an identification code as meta information in order to distinguish the issued electronic fingerprint download window from electronic fingerprint download windows issued to other distributors, wherein the identification code is constituted with a combination of alphabet characters and numbers.

When the distributor is issued the electronic fingerprint download window through the aforementioned transaction system, the distributor copies the electronic fingerprint download window to the clipboard of the distributor device and then displays the electronic fingerprint download window in a web environment. When a purchaser clicks the electronic fingerprint download window 500 displayed in a specific web environment, the intermediate system retrieves a digital content list from the product database unit of the intermediate system in real time at the time point at which the purchaser clicks the electronic fingerprint download window 500, and then arranges the digital content list on the purchaser device, differently from the first embodiment of the present invention, in which a product list window including a determined digital content list is provided when a download window is clicked.

Referring to FIG. 7, it is assumed that a specific distributor is issued a generated electronic fingerprint download window corresponding to the Monday-Tuesday drama “Boys Over Flowers” and displays the electronic fingerprint download window on a “Boys Over Flowers”-related café bulletin board. When a first purchaser clicks the electronic fingerprint download window 500 for “Boys Over Flowers” on Jan. 7, 2009, the first purchaser is provided with a digital content list of the first to fourth episodes of “Boys Over Flowers.” Meanwhile, when a second purchaser clicks the electronic fingerprint download window 500 for “Boys Over Flowers” on Jan. 28, 2009, the second purchaser is provided with a digital content list of the first to eighth episodes of “Boys Over Flowers.”

This is because the transaction system using the electronic fingerprint download window 500 according to the second embodiment of the present invention provides a digital content product in real time in consideration not of the time point at which the download window is displayed in a web environment, but of the time point at which a purchaser clicks the electronic fingerprint download window 500.

That is, when a purchaser clicks the electronic fingerprint download window 500, an electronic fingerprint matching the clicked electronic fingerprint download window 500 is extracted and applied to the product database unit of the intermediate system in real time, so that the purchaser and the distributor can consecutively transact the latest digital content, even with only one electronic fingerprint download window 500 first displayed in a specific web environment.

The digital content transaction system using an electronic fingerprint download window according to the embodiments of the present invention, described and illustrated above, is constructed such that a distributor is issued a generated electronic fingerprint download window and displays the issued electronic fingerprint download window in a web environment, and the transaction of a digital content is achieved when a purchaser clicks the displayed electronic fingerprint download window.

In addition, the technical characteristic of the electronic fingerprint download window according to the present invention may be utilized according to the following scheme. That is, when a purchaser registers his/her favorite content as “content of interest” with the intermediate system, the intermediate system sets an extraction factor for searching and extracting the digital content of interest from the product database unit of the intermediate system, and then generates and provides a download window matching the extraction factor, not to a distributor but to the purchaser.

The extraction factor represents a combination of one or more items selected from among an electronic fingerprint, a search word, and a related term (e.g. MID, war, or finance) about digital content selected by the purchaser device.

When the purchaser is issued a download window, the purchaser copies and displays the download window in an Internet space in which the purchaser is frequently active. Next, when the purchaser accesses the Internet space in which the purchaser has displayed the download window, clicks the electronic fingerprint download window, the purchaser can be provided with the latest digital content at any time.

That is, similar to the second embodiment of the present invention, when the purchaser clicks a corresponding download window, an extraction factor matching the download window is applied to the product database unit of the intermediate system in real time, so that the purchaser can be consecutively provided with the latest digital content, even with only the electronic fingerprint download window that the purchaser has first displayed in a specific web environment.

Especially, a purchaser, who uses digital content such as a consecutively airing drama, can be directly provided with content of interest in real time only by accessing his/her favorite Internet space, even without performing the troublesome conventional task of separately accessing a web site which provides a specific P2P service and searching for target content whenever a new episode of the drama comes out, so that there is an advantage in that the purchaser can enjoy increased convenience.

In addition, the present invention may be constructed such that a download window, generated and issued by the intermediate system, requests the purchaser to set a day of the week and a date, and the purchaser transmits set information to an email address that the purchaser has registered with the intermediate system.

While the exemplary embodiments of the invention have been shown and described with specified terms, the terms have been used for illustrative purposes, and those skilled in the art may make various changes in form and details without departing from the scope of the invention which is defined by the appended claims. Exemplary embodiments of the present invention have been disclosed herein and, although specific terms are employed, they are used and are to be interpreted in a generic and descriptive sense only and not for purposes of limitation. Accordingly, it will be understood by those of ordinary skill in the art that various changes in form and details may be made without departing from the spirit and scope of the present invention as set forth in the following claims.

For example, a download window according to an exemplary embodiment of the present invention may be constructed to be issued through a bundle product list window, which is provided when a bundle product cart button, included in a digital content list screen provided to a distributor device, is clicked.

However, the transaction system may be constructed such that a download window issuance button, instead of the bundle product cart button, is provided on the digital content list screen, and download window issuance can be requested directly when a selection task has been completed using bundle product selection boxes, which is enough to achieve the purpose of the present invention.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A digital content transaction system using a download window which provides a means for digital content product transaction between a distributor and a purchaser through a distributor device and a purchaser device, the digital content transaction system comprising:
an intermediate system for providing a digital content list screen to allow the distributor to select products to be transacted, generating a download window matching a list of the selected bundle product, copying the download window to a web environment, and providing the copied download window to the purchaser device,
wherein a product selection window, in which the bundle product is arranged, is displayed when the download window is clicked by the purchaser device.

2. The digital content transaction system according to claim 1, wherein the digital content list screen comprises:
a bundle product selection box for selecting a digital content targeted by the distributor; and
a bundle product cart button for temporarily storing a bundle product selected and constructed through the bundle product selection box,
wherein a bundle product list window, in which a temporarily-stored bundle product list is arranged, is activated and provided when the bundle product cart button is clicked, and the bundle product list window is provided at a predetermined area thereof with a download window issuance button.

3. The digital content transaction system according to claim 1, wherein the digital content list screen comprises a bundle product selection box for selecting a digital content targeted by the distributor, and the digital content list screen is provided at a predetermined area thereof with a download window issuance button.

4. The digital content transaction system according to claim 2, wherein, when the download window issuance button is clicked, a bundle product code for distinction from other distributors and other bundle products is issued, and a download window comprising the bundle product code as meta information is generated and provided to a clipboard of the distributor device.

5. The digital content transaction system according to claim 1, wherein the product selection window provided when the download window is clicked comprises:
a product selection box for selecting a product desired by the purchaser; and
a download button for downloading the selected product and processing payment.

6. The digital content transaction system according to claim 5, wherein the product selection window further comprises a search window for searching the intermediate system for a digital content other than a bundle product arranged in the product selection window and additionally providing the searched digital content.

7. The digital content transaction system according to claim 2, wherein the bundle product list window, which is activated when the bundle product cart button is clicked, provides a sales policy setup column so that the distributor directly sets a sales policy, or a sales policy setup window for setting a sales policy is provided when the download window issuance button is clicked.

8. The digital content transaction system according to claim 1, wherein the intermediate system requests a provider device, which is to register a digital content product with the intermediate system, to set whether generation of a download window for the digital content product to be registered is allowed.

9. The digital content transaction system according to claim 1, wherein the download window is provided in at least one form selected from image, hyper text makeup language (HTML), and uniform resource locator (URL) forms.

10. The digital content transaction system according to claim 9, wherein providing the download window in the image form is achieved by a series of executions of establishing an area on which the image exists, selecting the area, and copying the image on a clipboard of the distributor device.

11. The digital content transaction system according to claim 4, wherein the bundle product code is constituted with a combination of numbers or alphabet characters.

12. A digital content transaction system using a download window which provides a means for digital content product transaction between a distributor and a purchaser through a distributor device and a purchaser device, the digital content transaction system comprising:
an intermediate system for providing a digital content list screen to allow the distributor to select digital contents desired to be transacted, extracting an electronic fingerprint for confirmed digital contents, generating and issuing a download window matching the extracted electronic fingerprint, and copying the issued electronic fingerprint to a web environment,
wherein, when the displayed download window is clicked by the purchaser device, a digital content list related to the electronic fingerprint matching the download window is extracted from digital contents stored in the intermediate system, and the extracted digital content list is provided to the purchaser device.

13. A digital content transaction system using a download window which provides a means for digital content product transaction between a distributor and a purchaser through a distributor device and a purchaser device, the digital content transaction system comprising:
an intermediate system for allowing the purchaser device to register digital contents of interest which the purchaser prefers, setting an extraction factor for searching and extracting a content related to the registered digital content of interest from digital contents stored in the intermediate system, generating and issuing a download window matching the extraction factor, and copying the issued download window to a web environment,
wherein, when the displayed download window is clicked by the purchaser device, a digital content product list related to the extraction factor matching the download window is provided to the purchaser device.

14. The digital content transaction system according to claim 13, wherein the extraction factor comprises at least one selected from an electronic fingerprint, a search word, and a related term for digital content which is selected by the purchaser device.

15. The digital content transaction system according to claim 13, wherein the download window generated and issued by the intermediate system is provided to an email address which has been registered with the intermediate system by the purchaser.

16. A digital content transaction method using a download window which provides a means for digital content product transaction between a distributor and a purchaser through a distributor device and a purchaser device, the digital content transaction method comprising:
allowing the distributor to select transaction products, which are to be transacted among a list of registration products registered by the distributor, on a digital content list screen;
generating a download window to which the selected transaction products are allocated and in which a bundle product code for distinction from other distributors and other bundle products is included as meta information;
copying the generated download window to a web environment and providing the copied download window to the purchaser device;
providing a product selection window, in which a bundle product list is arranged, when the download window is clicked by the purchaser device;
allowing the purchaser device to select a desired specific product from a bundle product provided through the product selection window, and requesting a payment to be made.

17. The digital content transaction method according to claim 16, wherein the digital content list screen comprises:
a bundle product selection box for selecting a digital content targeted by the distributor; and
a bundle product cart button for temporarily storing a bundle product selected and constructed through the bundle product selection box,
wherein a bundle product list window, in which a temporarily-stored bundle product list is arranged, is activated and provided when the bundle product cart button is clicked, and the bundle product list window is provided at a predetermined area thereof with a download window issuance button.

18. The digital content transaction method according to claim 16, wherein the digital content list screen comprises a bundle product selection box for selecting a digital content targeted by the distributor, and the digital content list screen is provided at a predetermined area thereof with a download window issuance button.

19. The digital content transaction method according to claim 17, wherein when the download window issuance button is clicked, a bundle product code for distinction from other distributors and other bundle products is issued, and a download window comprising the bundle product code as meta information is generated and provided to a clipboard of the distributor device.

20. The digital content transaction method according to claim 16, wherein the product selection window provided when the download window is clicked comprises:
a product selection box for selecting a product desired by the purchaser; and
a download button for downloading the selected product and processing payment.

21. The digital content transaction method according to claim 20, wherein the product selection window further comprises a search window for searching the intermediate system for a digital content other than a bundle product arranged in the product selection window and additionally providing the searched digital content.

22. The digital content transaction method according to claim 17, wherein the bundle product list window, which is activated when the bundle product cart button is clicked, provides a sales policy setup column so that the distributor directly sets a sales policy, or a sales policy setup window for setting a sales policy is provided when the download window issuance button is clicked.

23. The digital content transaction method according to claim 16, wherein the download window is provided in at least one form selected from image, hyper text makeup language (HTML), and uniform resource locator (URL) forms.

24. The digital content transaction method according to claim 23, wherein providing the download window in the image form is achieved by a series of executions of establishing an area on which the image exists, selecting the area, and copying the image on a clipboard of the distributor device.
